(19) United States
(12) Patent Application Publication
(10) Pub. No.: US 2026/0237093 A1
(43) Pub. Date: Aug. 13, 2026

(54) GENERATING CORRECTED HEAD POSE DATA USING A HARMONIC EXPONENTIAL FILTER

(71) Applicant: GOOGLE LLC, Mountain View, CA (US)

(72) Inventor: Claude Knaus, Mountain View, CA (US)

(21) Appl. No.: 19/154,301

(22) PCT Filed: Mar. 8, 2023
(86) PCT No.: PCT/US2023/063945

§ 371 Date: Aug. 6, 2025

(51) Int. Cl. G06T 7/73; G06F 3/01; G06F 3/0346; G06T 7/277; G06V 40/16

(52) U.S. Cl. CPC G06T 7/73; G06F 3/012; G06F 3/0346; G06T 7/277; G06V 40/168

(57) ABSTRACT

A method including receiving image data, generating head pose data based on the image data, and inputting the head pose data into a harmonic exponential filter to generate corrected head pose data.

### FIELD

Implementations relate to video conference devices, and in particular, to three-dimensional (3D) telepresence systems. Implementations relate to head mounted wearable devices, and in particular, to head mounted wearable computing devices including a display device.

### BACKGROUND

Three-dimensional (3D) telepresence systems can rely on 3D pose information for a user's head to determine where to display video and to project audio. The 3D pose information needs to be accurate. For example, some systems can be accurate, but require the user to wear 3D marker balls. Furthermore, these systems are extremely expensive with a hardware footprint that is large. Other systems can use small consumer-grade devices that can be used, for example, for gaming. However. These systems have an accuracy and speed that does not meet the requirements of a 3D telepresence system.

Visual odometry is a computer vision technique for estimating a six-degree-of-freedom (6DoF) pose (position and orientation)—and in some cases, velocity—of a camera moving relative to a starting position. When movement is tracked, the camera performs navigation through a region. Visual odometry works by analyzing sequential images from the camera and tracking objects in the images that appear in the sequential images. Visual odometry can be used in head tracking.

Head pose tracking in a 3D telepresence system and/or a system using visual odometry (e.g., head tracking using cameras) can introduce a significant latency (e.g., dozens of milliseconds). Signal processing filters like exponential smoothing, a double exponential filter, a Kalman filter, and the like may not address repetitive motion as they do not identify a frequency of motion.

### SUMMARY

Implementations described herein are related to head pose tracking in an augmented reality (AR) system.

Augmented reality and virtual reality (AR/VR) systems that do not use wearable devices, for example, auto-stereoscopic/no-glasses telepresence systems that use a stationary 3D display, may rely on having an accurate up-to-date 3D pose of the user's facial features (e.g., eyes and ears). For example, in these systems (e.g., 3D telepresence systems), accurate eye tracking can be used to modify the displayed scene by positioning a virtual camera and projecting separate left and right stereo images to the left and right eye respectively. Conventionally, the data representing the 3D head pose of the user may be input into a double exponential filter or a Kalman filter to provide a corrected 3D head pose. In an example implementation, the data representing the 3D head pose of the user can be input into a harmonic exponential filter to provide a corrected 3D head pose.

An image can be used to derive a first 6DoF pose of a camera of a wearable device. This 6DoF pose can be combined with a second, predicted 6DoF pose based on compensated rotational velocity and acceleration measurements derived from IMU intrinsic values (e.g., gyro bias, gyro misalignment). Conventionally, each of the first and second 6DoF poses may be input into a Kalman filter to provide a corrected 6DoF pose and the IMU intrinsic values. In an example implementation, the first 6DoF pose can be input into a harmonic exponential filter to provide a corrected 6DoF pose and the IMU data may not be corrected and/or not used. In another example implementation, each of the first and second 6DoF poses can be input into a harmonic exponential filter to provide a corrected 6DoF pose and the IMU intrinsic values. In another example implementation, each of the first 6DoF pose can be input into a harmonic exponential filter and the second 6DoF pose may be input into an Kalman filter to provide a corrected 6DoF pose and the IMU intrinsic values.

In a general aspect, a device, a system, a non-transitory computer-readable medium (having stored thereon computer executable program code which can be executed on a computer system), and/or a method can perform a process with a method including receiving image data representing an image of a scene from a world-facing camera on a frame of a smartglasses device, generating six-degree-of-freedom head pose data based on the image data, and inputting the six-degree-of-freedom head pose data into a harmonic exponential filter to generate corrected six-degree-of-freedom head pose data.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 is a block diagram illustrating an example 3D content system for displaying content on a display device, according to at least one example implementation.

FIG. 2A illustrates an example head mounted wearable device worn by a user.

FIG. 2B is a front view, and FIG. 2C is a rear view of the example head mounted wearable device shown in FIG. 2A.

FIG. 3A is a diagram illustrating an example of a world-facing camera with associated IMU on a smartglasses frame according to an example implementation.

FIG. 3B is a diagram illustrating an example scene in which a user may perform inertial odometry using the AR smartglasses according to an example implementation.

FIG. 4 is a block diagram of an example system for modelling content for render in a display device, according to at least one example implementation.

FIG. 5 is a diagram illustrating an example apparatus for performing the head pose data correction according to an example implementation.

FIG. 6 is a block diagram of a system for tracking and correcting head pose data according to at least one example embodiment.

FIG. 7 is a flow chart illustrating an example flow for generating corrected head pose data according to an example implementation.

FIG. 8 illustrates a method of generating corrected head pose data according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Implementations relate to reconstructing harmonic motions that have been distorted by latency and additive gaussian noise. Predicting head motion, in particular nodding and shaking of head, can be difficult because of the relatively rapid movement associated with these motions. For example, in virtual reality (VR) and/or augmented reality (AR) settings, head tracking may not be reliably performed using relatively low-latency inertial measurement unit (IMU) measurements especially when the movements are relatively rapid. In systems using camera-based head tracking, which includes a computing pipeline (e.g., including processing and communicating data and/or signals), latencies (e.g., a delay in determining and using data) until the head pose is determined can be introduced. For example, determining head pose(s) (e.g., changes in head pose) before rendering an image can be visible to the user as, for example, blurry objects, misplaced objects, a shifted image, and/or the like which can reduce the quality of a user experience. This latency can be referred to as motion-to-photon (MTP) latency. Predicting fast motions like head nodding and shaking, as mentioned above, can be challenging due to MTP latencies. Therefore, a technical problem with existing camera-based head tracking that a pose error can be introduced due to the MTP latencies.

Human head motion can be harmonic. In other words, natural body motions can be biased towards conserving energy. For example, body motions can be similar to a system consisting of dampened springs. For example, head nodding can produce approximately sinusoidal motions. Therefore, as described herein, harmonics can be used to solve the problems described above. For example, implementations can generate a head pose predictor that takes advantage of harmonic motions. Accordingly, to solve this problem a head pose generated based on an image(s) can be input into a harmonic exponential filter to provide a corrected head pose. The harmonic exponential filter can be an extension to exponential filters (e.g., double and/or triple exponential filters) by filtering many components that are of interest (e.g., position, velocity, acceleration, velocity-acceleration phasor, change of phasor, and/or the logarithm of the change of phasor). Therefore, the harmonic exponential filter can combine two (2) to six (6) exponential filters.

Example implementations can use the harmonic exponential filter to solve the problems described above by (1) extending exponential smoothing to multiple arbitrary features derived from the input sample, (2) estimating a dominant frequency (e.g., based on complex arithmetic) with velocity-accelerator phasor, and/or (3) improving prediction and extrapolation by assuming harmonic motion.

Augmented reality and virtual reality (AR/VR) systems that do not use wearable devices (e.g., head mounted displays (HMDs)), for example, auto-stereoscopic/no-glasses telepresence systems that use a stationary 3D display, may rely on having an accurate up-to-date 3D pose of the user's facial features (e.g., eyes and ears). For example, in these systems (e.g., 3D telepresence systems), accurate eye tracking can be used to modify the displayed scene by positioning a virtual camera and projecting separate left and right stereo images to the left and right eye respectively. Conventionally, the data representing the 3D head pose of the user may be input into a double exponential filter or a Kalman filter to provide a corrected 3D head pose. In an example implementation, the data representing the 3D head pose of the user can be input into a harmonic exponential filter to provide a corrected 3D head pose.

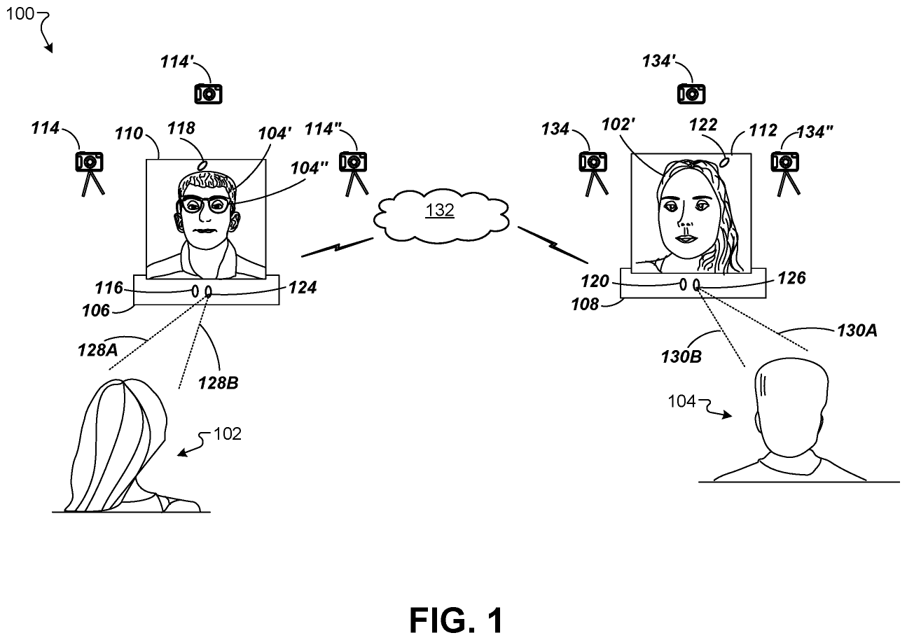

FIG. 1 is a block diagram illustrating an example 3D content system 100 for capturing and displaying content in a stereoscopic display device, according to implementations described throughout this disclosure. The 3D content system 100 can be used by multiple users to, for example, conduct videoconference communications in 3D (e.g., 3D telepresence sessions). In general, the system of FIG. 1 may be used to capture video and/or images of users during a videoconference and use the systems and techniques described herein to generate virtual camera, display, and audio positions.

System 100 may benefit from the use of position generating systems and techniques described herein because such techniques can be used to project video and audio content in such a way to improve a video conference. For example, video can be projected to render 3D video based on the position of a viewer and to project audio based on the position of participants in the video conference. The example 3D content system 100 can be configured to use a harmonic exponential filter to generate corrected head pose data. For example, the 3D content system 100 can include signal processing pipeline including the harmonic exponential filter. The signal processing pipeline can receive an image(s) and generate head pose data based on the images. The head pose data can include errors (e.g., due to rapid head movement like nodding and shaking of the head). Therefore, the signal processing pipeline can include the harmonic exponential filter to correct for (e.g., reduce, minimize, and/or the like) the errors. Accordingly, the 3D content system 100 can be configured to at least address some of the technical problems described above.

As shown in FIG. 1, the 3D content system 100 is being used by a first user 102 and a second user 104. For example, the users 102 and 104 are using the 3D content system 100 to engage in a 3D telepresence session. In such an example, the 3D content system 100 can allow each of the users 102 and 104 to see a highly realistic and visually congruent representation of the other, thereby facilitating the users to interact in a manner similar to being in the physical presence of each other.

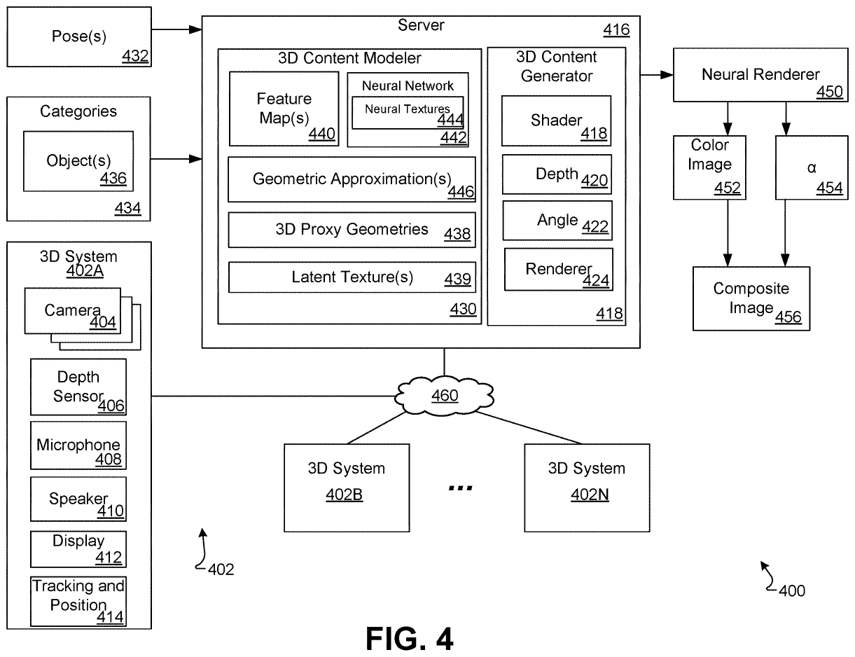

Each user 102, 104 can have a corresponding 3D system. Here, the user 102 has a 3D system 106 and the user 104 has a 3D system 108. The 3D systems 106, 108 can provide functionality relating to 3D content, including, but not limited to: capturing images for 3D display, processing and presenting image information, and processing and presenting audio information. The 3D system 106 and/or 3D system 108 can constitute a collection of sensing devices integrated as one unit. The 3D system 106 and/or 3D system 108 can include some or all components described with reference to FIG. 4.

The 3D systems 106, 108 can include multiple components relating to the capture, processing, transmission, positioning, or reception of 3D information, and/or to the presentation of 3D content. The 3D systems 106, 108 can include one or more cameras for capturing image content for images to be included in a 3D presentation and/or for capturing faces and facial features. Here, the 3D system 106 includes cameras 116 and 118. For example, the camera 116 and/or camera 118 can be disposed essentially within a housing of the 3D system 106, so that an objective or lens of the respective camera 116 and/or 118 captured image content by way of one or more openings in the housing. In some implementations, the camera 116 and/or 118 can be separate from the housing, such as in form of a standalone device (e.g., with a wired and/or wireless connection to the 3D system 106). As shown in FIG. 1, at least one camera 114, 114′ and/or 114″ are illustrated as being separate from the housing as standalone devices which can be communicatively coupled (e.g., with a wired and/or wireless connection) to the 3D system 106.

In an example implementation, a plurality of cameras can be used to capture at least one image. The plurality of cameras can be used to capture two or more images. For example, two or more images can be captured sequentially by the same camera (e.g., for tracking). Two or more images can be captured at the same time by two or more cameras (e.g., to be used for triangulation).

The cameras 114, 114′, 114″, 116 and 118 can be positioned and/or oriented so as to capture a sufficiently representative view of a user (e.g., user 102). While the cameras 114, 114′, 114″, 116 and 118 generally will not obscure the view of the 3D display 110 for the user 102, the placement of the cameras 114, 114′, 114″, 116 and 118 can be arbitrarily selected. For example, one of the cameras 116, 118 can be positioned somewhere above the face of the user 102 and the other can be positioned somewhere below the face. Cameras 114, 114′ and/or 114″ can be placed to the left, to the right, and/or above the 3D system 106. For example, one of the cameras 116, 118 can be positioned somewhere to the right of the face of the user 102 and the other can be positioned somewhere to the left of the face. The 3D system 108 can include an analogous way to include cameras 120, 122, 134, 134′, and/or 134″, for example. Additional cameras are possible. For example, a third camera may be placed near or behind display 110.

The 3D content system 100 can include one or more 2D or 3D displays. Here, a 3D display 110 is provided for the 3D system 106, and a 3D display 112 is provided for the 3D system 108. The 3D displays 110, 112 can use any of multiple types of 3D display technology to provide an autostereoscopic view for the respective viewer (here, the user 102 or user 104, for example). In some implementations, the 3D displays 110, 112 may be a standalone unit (e.g., self-supported or suspended on a wall). In some implementations, the 3D displays 110, 112 can include or have access to wearable technology (e.g., controllers, a head-mounted display, etc.).

In general, 3D displays, such as displays 110, 112 can provide imagery that approximates the 3D optical characteristics of physical objects in the real world without the use of a head-mounted display (HMD) device. In general, the displays described herein include flat panel displays, lenticular lenses (e.g., microlens arrays), and/or parallax barriers to redirect images to a number of different viewing regions associated with the display.

In some implementations, the displays 110, 112 can be a flat panel display including a high-resolution and glasses-free lenticular three-dimensional (3D) display. For example, displays 110, 112 can include a microlens array (not shown) that includes a plurality of lenses (e.g., microlenses) with a glass spacer coupled (e.g., bonded) to the microlenses of the display. The microlenses may be designed such that, from a selected viewing position, a left eye of a user of the display may view a first set of pixels while the right eye of the user may view a second set of pixels (e.g., where the second set of pixels is mutually exclusive to the first set of pixels).

In some example 3D displays, there may be a single location that provides a 3D view of image content (e.g., users, objects, etc.) provided by such displays. A user may be seated in the single location to experience proper parallax, little distortion, and realistic 3D images. If the user moves to a different physical location (or changes a head position or eye gaze position), the image content (e.g., the user, objects worn by the user, and/or other objects) may begin to appear less realistic, 2D, and/or distorted. Therefore, the techniques described herein can enable accurately determining user position (e.g., user eyes) to enable generation of realistic 3D. The systems and techniques described herein may reconfigure the image content projected from the display to ensure that the user can move around, but still experience proper parallax, low rates of distortion, and realistic 3D images in real time. Thus, the systems and techniques described herein provide the advantage of maintaining and providing 3D image content an objects for display to a user regardless of any user movement that occurs while the user is viewing the 3D display.

As shown in FIG. 1, the 3D content system 100 can be connected to one or more networks. Here, a network 132 is connected to the 3D system 106 and to the 3D system 108. The network 132 can be a publicly available network (e.g., the Internet), or a private network, to name just two examples. The network 132 can be wired, or wireless, or a combination of the two. The network 132 can include, or make use of, one or more other devices or systems, including, but not limited to, one or more servers (not shown).

The 3D systems 106, 108 can include face finder/recognition tools. The 3D systems 106, 108 can include facial feature extractor tools. For example, the 3D systems 106, 108 can include machine learned (ML) tools (e.g., software) configured to identify faces in an image and extract facial features and the position (or x, y, z location) of the facial features. The image(s) can be captured using cameras 114, 114′, 114″, 116 and/or 118 (for 3D system 106) and using cameras 120, 122, 134, 134′, and/or 134″ (for 3D system 108).

The 3D systems 106, 108 can include one or more depth sensors to capture depth data to be used in a 3D presentation. Such depth sensors can be considered part of a depth capturing component in the 3D content system 100 to be used for characterizing the scenes captured by the 3D systems 106 and/or 108 in order to correctly represent the scenes on a 3D display. In addition, the system can track the position and orientation of the viewer's head, so that the 3D presentation can be rendered with the appearance corresponding to the viewer's current point of view. Here, the 3D system 106 includes a depth sensor 124. In an analogous way, the 3D system 108 can include a depth sensor 126. Any of multiple types of depth sensing or depth capture can be used for generating depth data.

In some implementations, an assisted-stereo depth capture is performed. The scene can be illuminated using dots of lights, and stereo-matching can be performed between two respective cameras, for example. This illumination can be done using waves of a selected wavelength or range of wavelengths. For example, infrared (IR) light can be used. In some implementations, depth sensors may not be utilized when generating views on 2D devices, for example. Depth data can include or be based on any information regarding a scene that reflects the distance between a depth sensor (e.g., the depth sensor 124) and an object in the scene. The depth data reflects, for content in an image corresponding to an object in the scene, the distance (or depth) to the object. For example, the spatial relationship between the camera(s) and the depth sensor can be known and can be used for correlating the images from the camera(s) with signals from the depth sensor to generate depth data for the images.

The images captured by the 3D content system 100 can be processed and thereafter displayed as a 3D presentation. As depicted in the example of FIG. 1, 3D image 104′ with object (eyeglasses 104″) are presented on the 3D display 110. As such, the user 102 can perceive the 3D image 104′ and eyeglasses 104″ as a 3D representation of the user 104, who may be remotely located from the user 102. 3D image 102′ is presented on the 3D display 112. As such, the user 104 can perceive the 3D image 102′ as a 3D representation of the user 102.

The 3D content system 100 can allow participants (e.g., the users 102, 104) to engage in audio communication with each other and/or others. In some implementations, the 3D system 106 includes a speaker and microphone (not shown). For example, the 3D system 108 can similarly include a speaker and a microphone. As such, the 3D content system 100 can allow the users 102 and 104 to engage in a 3D telepresence session with each other and/or others.

Augmented reality and virtual reality (AR/VR) systems that do use wearable devices, for example, head mounted displays (HMD), smartglasses, and the like. In some wearable devices, an image can be used to derive a first 6DoF pose of a camera. This 6DoF pose can be combined with a second, predicted 6DoF pose based on compensated rotational velocity and acceleration measurements derived from IMU intrinsic values (e.g., gyro bias, gyro misalignment). Conventionally, each of the first and second 6DoF poses may be input into a Kalman filter to provide a corrected 6DoF pose and the IMU intrinsic values. In an example implementation, the first 6DoF pose can be input into a harmonic exponential filter to provide a corrected 6DoF pose.

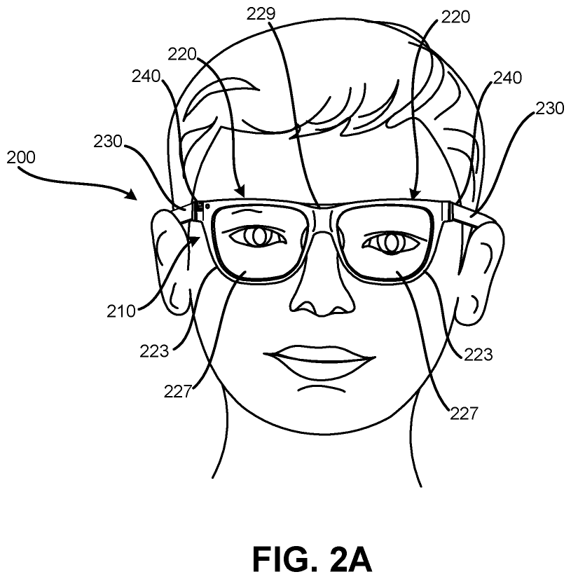

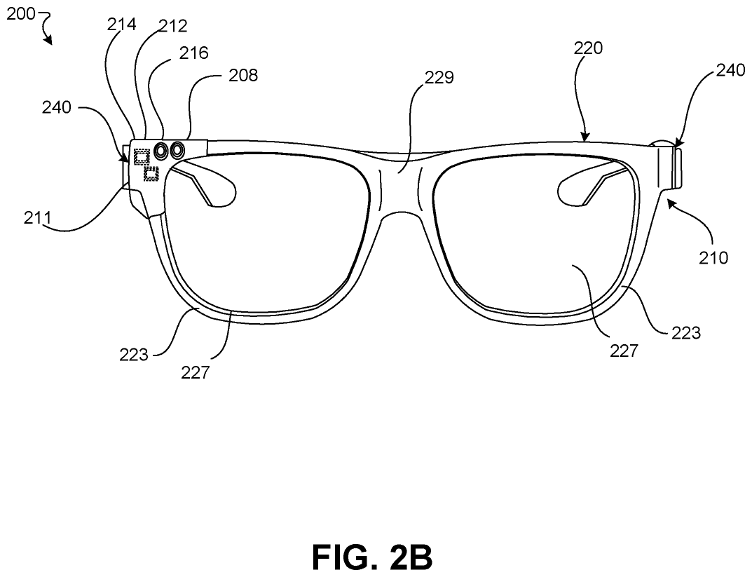

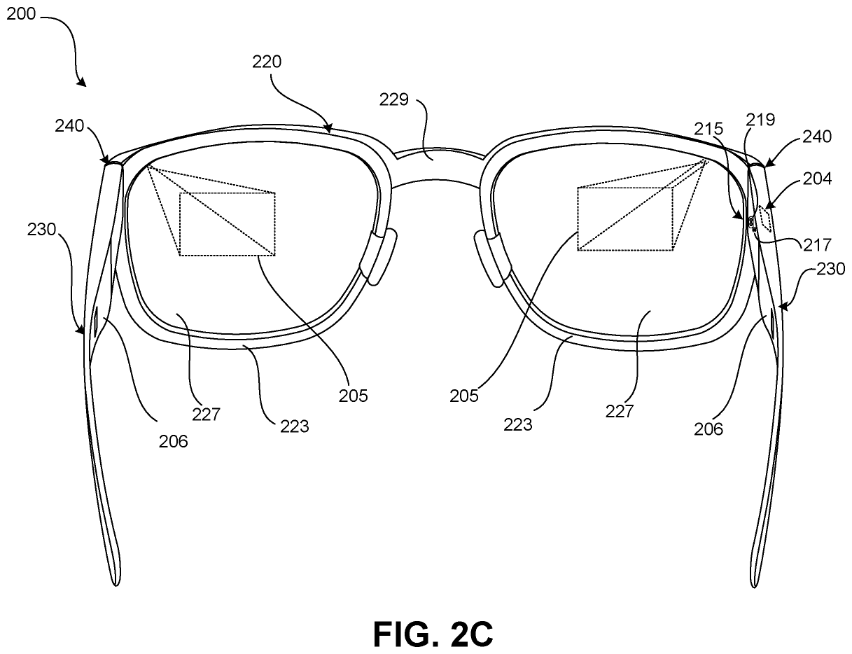

FIG. 2A illustrates a user wearing an example smartglasses 200, including display capability, eye/gaze tracking capability, and computing/processing capability. FIG. 2B is a front view, and FIG. 2C is a rear view of the example smartglasses 200 shown in FIG. 2A. The example smartglasses 200 can be configured to use a harmonic exponential filter to generate corrected head pose data. For example, the example smartglasses 200 can include signal processing pipeline including the harmonic exponential filter. The signal processing pipeline can receive an image(s) and generate head pose data based on the images. The head pose data can include errors (e.g., due to rapid head movement like nodding and shaking of the head). Therefore, the signal processing pipeline can include the harmonic exponential filter to correct for (e.g., reduce, minimize, and/or the like) the errors. Accordingly, the smartglasses 200 can be configured to at least address some of the technical problems described above.

The example smartglasses 200 includes a frame 210. The frame 210 includes a front frame portion 220, and a pair of temple arm portions 230 rotatably coupled to the front frame portion 220 by respective hinge portions 240. The front frame portion 220 includes rim portions 223 surrounding respective optical portions in the form of lenses 227, with a bridge portion 229 connecting the rim portions 223. The temple arm portions 230 are coupled, for example, pivotably or rotatably coupled, to the front frame portion 220 at peripheral portions of the respective rim portions 223. In some examples, the lenses 227 are corrective/prescription lenses. In some examples, the lenses 227 are an optical material including glass and/or plastic portions that do not necessarily incorporate corrective/prescription parameters.

In some examples, the smartglasses 200 includes a display device 204 that can output visual content, for example, at an output coupler 205, so that the visual content is visible to the user. In the example shown in FIGS. 2B and 2C, the display device 204 is provided in one of the two arm portions 230, simply for purposes of discussion and illustration. Display devices 204 may be provided in each of the two arm portions 230 to provide for binocular output of content. In some examples, the display device 204 may be a see-through near eye display. In some examples, the display device 204 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 227, next to content (for example, digital images, user interface elements, virtual content, and the like) output by the display device 204. In some implementations, waveguide optics may be used to depict content on the display device 204. The digital images can be rendered at an offset from the physical items in the world due to errors in head pose data. Therefore, example implementations can use a harmonic exponential filter in a head pose signal processing pipeline to correct for the errors in the head pose data.

In some examples, the smartglasses 200 includes one or more of an audio output device 206 (such as, for example, one or more speakers), an illumination device 208, a sensing system 211, a control system 212, at least one processor 214, and an outward facing image sensor, or world-facing camera 216. In an example implementation, the outward facing image sensor, or world-facing camera 216 can be used to generate image data used to generate head pose data. This head pose data can include errors that can be corrected using a harmonic exponential filter.

In some examples, the sensing system 211 may include various sensing devices and the control system 212 may include various control system devices including, for example, one or more processors 214 operably coupled to the components of the control system 212. In some examples, the control system 212 may include a communication module providing for communication and exchange of information between the smartglasses 200 and other external devices. In some examples, the head mounted smartglasses 200 includes a gaze tracking device 215 to detect and track eye gaze direction and movement. The gaze tracking device 215 can include sensors 217, 219 (e.g., cameras). Data captured by the gaze tracking device 215 may be processed to detect and track gaze direction and movement as a user input. In the example shown in FIGS. 2B and 2C, the gaze tracking device 215 is provided in one of the two arm portions 230, simply for purposes of discussion and illustration. In the example arrangement shown in FIGS. 2B and 2C, the gaze tracking device 215 is provided in the same arm portion 230 as the display device 204, so that user eye gaze can be tracked not only with respect to objects in the physical environment, but also with respect to the content output for display by the display device 204. In some examples, gaze, or gaze tracking devices 215 may be provided in each of the two arm portions 230 to provide for gaze tracking of each of the two eyes of the user. In some examples, display devices 204 may be provided in each of the two arm portions 230 to provide for binocular display of visual content.

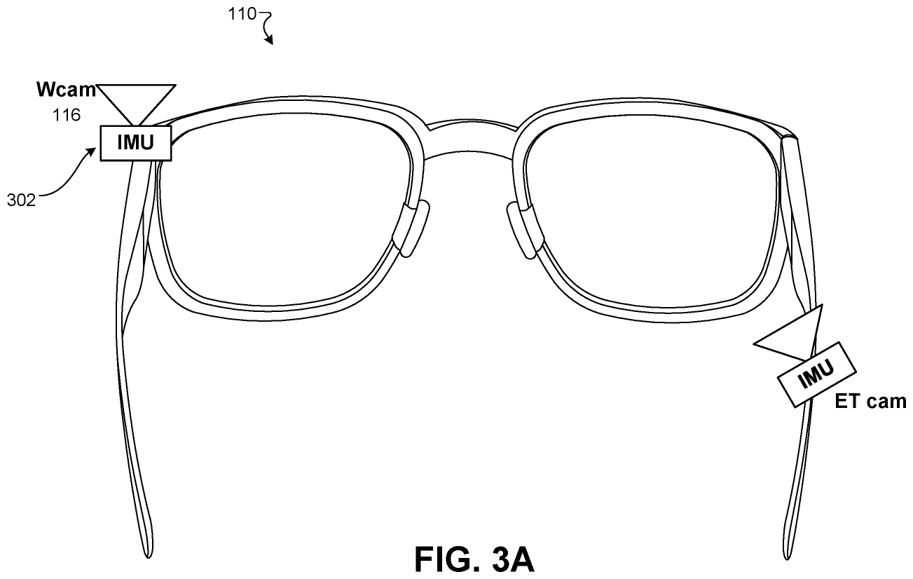

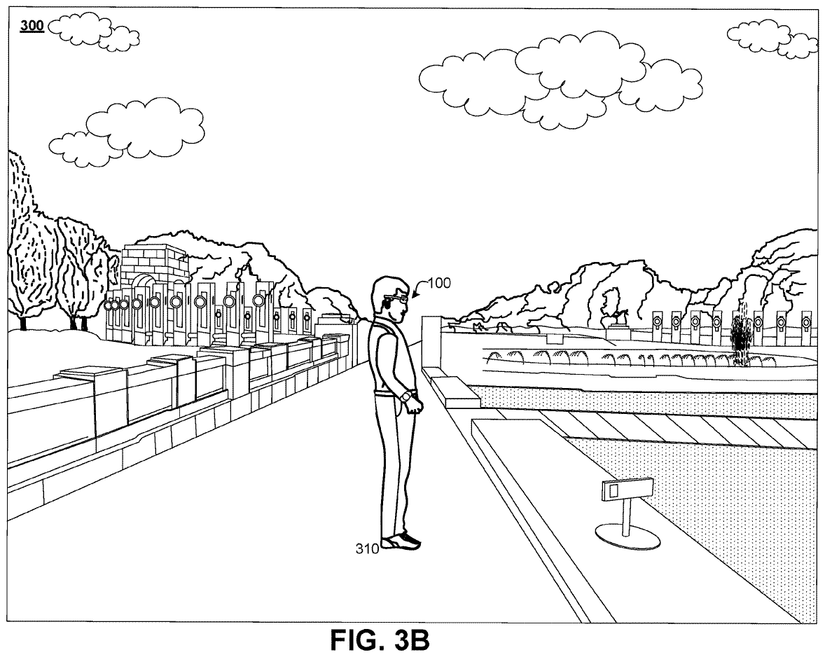

FIG. 3A is a diagram illustrating an example of a world-facing camera 216 on a smartglasses frame 210. As shown in FIG. 3A, the world-facing camera 216 has an attached inertial measurement unit (IMU) 302. The IMU 302 includes a set of gyros configured to measure rotational velocity and an accelerometer configured to measure an acceleration of camera 216 as the camera moves with the head and/or body or the user. In an example implementation, the world-facing camera 216 and/or the IMU 302 can be used in a head pose data generation operation (or processing pipeline). The head pose data generated based on image data generated by the world-facing camera 216 can include errors (e.g., due to rapid head movement like nodding and shaking of the head). The errors can be corrected (e.g., removed or minimized) using a harmonic exponential filter in the head pose data generation operation (or processing pipeline).

FIG. 3B is a diagram illustrating an example scene 300 in which a head pose and/or head pose tracking may be determined using the AR smartglasses 200. As shown in FIG. 3B, the user looks at the scene 300 at a location 310 within the scene 300. As the user looks at the scene 300 from the location 310, the world-facing camera 216 displays a portion of the scene 300 onto the display; that portion is dependent on the 6DoF pose of the camera 216 in the world coordinate system of the scene. As the user moves through the scene 300 and/or as the user rapidly moves her head, a head pose may be determined and used in head pose tracking.

FIG. 4 is a block diagram of an example system 400 for modelling content for render in a 3D display device, according to implementations described throughout this disclosure. The system 400 can serve as or be included within one or more implementations described herein, and/or can be used to perform the operation(s) of one or more examples of 3D processing, modelling, or presentation described herein. The overall system 400 and/or one or more of its individual components, can be implemented according to one or more examples described herein. The example system 400 can be configured to use a harmonic exponential filter to generate corrected head pose data. For example, the system 400 can include a signal processing pipeline including the harmonic exponential filter. The signal processing pipeline can receive an image(s) and generate head pose data based on the images. The head pose data can include errors (e.g., due to rapid head movement like nodding and shaking of the head). Therefore, the signal processing pipeline can include the harmonic exponential filter to correct for (e.g., reduce, minimize, and/or the like) the errors. Accordingly, the system 400 can be configured to at least address some of the technical problems described above.

The system 400 includes one or more 3D systems 402. In the depicted example, 3D systems 402A, 402B through 402N are shown, where the index N indicates an arbitrary number. The 3D system 402 can provide for capturing of visual and audio information for a 3D presentation and forward the 3D information for processing. Such 3D information can include images of a scene, depth data about the scene, and audio from the scene. For example, the 3D system 402 can serve as, or be included within, the 3D system 106 and 3D display 110 (FIG. 1). As described below, the 3D system 402 can include a tracking and position 414 block including, for example, the harmonic exponential filter. In other words, the signal processing pipeline configured to generate head pose data can include the tracking and position 414 block.

The system 400 may include multiple cameras, as indicated by cameras 404. Any type of light-sensing technology can be used for capturing images, such as the types of images sensors used in common digital cameras, monochrome cameras, and/or infrared cameras. The cameras 404 can be of the same type or different types. Camera locations may be placed within any location on (or external to) a 3D system such as 3D system 106, for example.

The system 402A includes a depth sensor 406. In some implementations, the depth sensor 406 operates by way of propagating IR signals onto the scene and detecting the responding signals. For example, the depth sensor 406 can generate and/or detect the beams 128A-B and/or 130A-B.

The system 402A also includes at least one microphone 408 and a speaker 410. For example, these can be integrated into a head-mounted display worn by the user. In some implementations, the microphone 408 and speaker 410 may be part of 3D system 106 and may not be part of a head-mounted display.

The system 402 additionally includes a 3D display 412 that can present 3D images in a stereoscopic fashion. In some implementations, the 3D display 412 can be a standalone display and in some other implementations the 3D display 412 can be included in a head-mounted display unit configured to be worn by a user to experience a 3D presentation. In some implementations, the 3D display 412 operates using parallax barrier technology. For example, a parallax barrier can include parallel vertical stripes of an essentially non-transparent material (e.g., an opaque film) that are placed between the screen and the viewer. Because of the parallax between the respective eyes of the viewer, different portions of the screen (e.g., different pixels) are viewed by the respective left and right eyes. In some implementations, the 3D display 412 operates using lenticular lenses. For example, alternating rows of lenses can be placed in front of the screen, the rows aiming light from the screen toward the viewer's left and right eyes, respectively.

The system 402A includes a tracking and position 414 block. The tracking and position 414 block can be configured to track a location of the user in a room. In some implementations, the tracking and position 414 block may track a location of the eyes of the user. In some implementations, the tracking and position 414 block may track a location of the head of the user. The tracking and position 414 block can be configured to determine the position of users, microphones, cameras and the like within the system 402. In some implementations, the tracking and position 414 block may be configured to generate virtual positions based on the face and/or facial features of a user. For example, the tracking and position block 414 may be configured to generate a position of a virtual camera based on the face and/or facial features of a user. In some implementations, the tracking and position 414 block can be implemented using cameras 114, 114′, 114″, 116 and/or 118 (for 3D system 106) and using cameras 120, 122, 134, 134′, and/or 134″ (for 3D system 108).

A latency can be introduced in the tracking and position block 414. This latency is sometimes referred to as motion-to-photon (MTP) latency. Therefore, predicting fast motions like head nodding and shaking, as mentioned above, can be challenging due to MTP latencies. In other words, the MTP latency can introduce a head pose error or noise in the head pose data. The errors (or noise) associated with the MTP latencies (as well as other errors or noise) can be minimized or reduced by filtering the head pose data calculated by the tracking and position 414 block. Accordingly, the tracking and position 414 block can include the harmonic exponential filter.

As mentioned above, human head motion can be harmonic. In other words, natural body motions can be biased towards conserving energy. Therefore, harmonics can be used to in a head pose correction operation. For example, implementations can generate a head pose predictor that takes advantage of harmonic motions. Therefore, example implementations can use harmonics to (1) extending exponential smoothing to multiple arbitrary features derived from the input sample, (2) estimating a dominant frequency (e.g., based on complex arithmetic) with velocity-accelerator phasor, and (3) improving prediction and extrapolation by assuming harmonic motion. The tracking and position 414 block can include the harmonic exponential filter configured to take advantage of harmonic motions. Further, the tracking and position 414 block may be configured to implement the methods and techniques described in this disclosure within the 3D system(s) 402.

The system 400 can include a server 416 that can perform certain tasks of data processing, data modeling, data coordination, and/or data transmission. The server 416 includes a 3D content generator 418 that can be responsible for rendering 3D information in one or more ways. This can include receiving 3D content (e.g., from the 3D system 402A), processing the 3D content and/or forwarding the (processed) 3D content to another participant (e.g., to another of the 3D systems 402).

Some aspects of the functions performed by the 3D content generator 418 can be implemented for performance by a shader 418. The shader 418 can be responsible for applying shading regarding certain portions of images, and also performing other services relating to images that have been, or are to be, provided with shading. For example, the shader 418 can be utilized to counteract or hide some artifacts that may otherwise be generated by the 3D system(s) 402.

Shading refers to one or more parameters that define the appearance of image content, including, but not limited to, the color of an object, surface, and/or a polygon in an image. In some implementations, shading can be applied to, or adjusted for, one or more portions of image content to change how those image content portion(s) will appear to a viewer. For example, shading can be applied/adjusted in order to make the image content portion(s) darker, lighter, transparent, etc.

The 3D content generator 418 can include a depth processing component 420. In some implementations, the depth processing component 420 can apply shading (e.g., darker, lighter, transparent, etc.) to image content based on one or more depth values associated with that content and based on one or more received inputs (e.g., content model input).

The 3D content generator 418 can include an angle processing component 422. In some implementations, the angle processing component 422 can apply shading to image content based on that content's orientation (e.g., angle) with respect to a camera capturing the image content. For example, shading can be applied to content that faces away from the camera angle at an angle above a predetermined threshold degree. This can allow the angle processing component 422 to cause brightness to be reduced and faded out as a surface turns away from the camera to name just one example.

The 3D content generator 418 includes a renderer module 424. The renderer module 424 may render content to one or more 3D system(s) 402. The renderer module 424 may, for example, render an output/composite image which may be displayed in systems 402, for example.

As shown in FIG. 4, the server 416 also includes a 3D content modeler 430 that can be responsible for modeling 3D information in one or more ways. This can include receiving 3D content (e.g., from the 3D system 402A), processing the 3D content and/or forwarding the (processed) 3D content to another participant (e.g., to another of the 3D systems 402). The 3D content modeler 430 may utilize architecture 400 to model objects, as described in further detail below.

Poses 432 may represent a pose associated with captured content (e.g., objects, scenes, etc.). In some implementations, the poses 432 may be detected and/or otherwise determined by a tracking system associated with system 100 and/or 400 (e.g., implemented using cameras 114, 114′, 114″, 116 and/or 118 (for 3D system 106) and using cameras 120, 122, 134, 134′, and/or 134″ (for 3D system 108). Such a tracking system may include sensors, cameras, detectors, and/or markers to track a location of all or a portion of a user. In some implementations, the tracking system may track a location of the user in a room. In some implementations, the tracking system may track a location of the eyes of the user. In some implementations, the tracking system may track a location of the head of the user.

In some implementations, the tracking system may track a location of the user (or location of the eyes or head of the user) with respect to a display device 412, for example, in order to display images with proper depth and parallax. In some implementations, a head location associated with the user may be detected and used as a direction for simultaneously projecting images to the user of the display device 412 via the microlenses (not shown), for example.

Categories 434 may represent a classification for particular objects 436. For example, a category 434 may be eyeglasses and an object may be blue eyeglasses, clear eyeglasses, round eyeglasses, etc. Any category and object may be represented by the models described herein. The category 434 may be used as a basis in which to train generative models on objects 436. In some implementations, the category 434 may represent a dataset that can be used to synthetically render a 3D object category under different viewpoints giving access to a set of ground truth poses, color space images, and masks for multiple objects of the same category.

Three-dimensional (3D) proxy geometries 438 represent both a (coarse) geometry approximation of a set of objects and a latent texture 439 of one or more of the objects mapped to the respective object geometry. The coarse geometry and the mapped latent texture 439 may be used to generate images of one or more objects in the category of objects. For example, the systems and techniques described herein can generate an object for 3D telepresence display by rendering the latent texture 439 onto a target viewpoint and accessing a neural rendering network (e.g., a differential deferred rendering neural network) to generate the target image on the display. To learn such a latent texture 439, the systems described herein can learn a low-dimensional latent space of neural textures and a shared deferred neural rendering network. The latent space encompasses all instances of a class of objects and allows for interpolation of instances of the objects, which may enable reconstruction of an instance of the object from few viewpoints.

Neural textures 444 represent learned feature maps 440 which are trained as part of an image capture process. For example, when an object is captured, a neural texture 444 may be generated using the feature map 440 and a 3D proxy geometry 438 for the object. In operation, system 400 may generate and store the neural texture 444 for a particular object (or scene) as a map on top of a 3D proxy geometry 438 for that object. For example, neural textures may be generated based on a latent code associated with each instance of the identified category and a view associated with the pose.

Geometric approximations 446 may represent a shaped-based proxy for an object geometry. Geometric approximations 446 may be mesh-based, shape-based (e.g., triangular, rhomboidal, square, etc.), free form versions of an object.

The neural renderer 450 may generate an intermediate representation of an object and/or scene, for example, that utilizes a neural network to render. Neural textures 444 may be used to jointly learn features on a texture map (e.g., feature map 440) along with a 5-layer U-Net, such as neural network 442 operating with neural renderer 450. The neural renderer 450 may incorporate view dependent effects by modelling the difference between true appearance (e.g., a ground truth) and a diffuse reprojection with an object-specific convolutional network, for example. Such effects may be difficult to predict based on scene knowledge and as such, GAN-based loss functions may be used to render realistic output.

The RGB color channel 452 (e.g., color image) represents three output channels. For example, the three output channels may include (i.e., a red color channel, a green color channel, and a blue color channel (e.g., RGB) representing a color image. In some implementations. In some implementations, the color channel 452 may be a YUV map indicating which colors are to be rendered for a particular image. In some implementations, the color channel 452 may be a CIE map. In some implementations, the color channel 452 may be an ITP map.

Alpha (a) 454 represents an output channel (e.g., a mask) that represents for any number of pixels in the object, how particular pixel colors are to be merged with other pixels when overlaid. In some implementations, the alpha 454 represents a mask that defines a level of transparency (e.g., semi transparency, opacity, etc.) of an object.

The exemplary components above are here described as being implemented in the server 416, which can communicate with one or more of the 3D systems 402 by way of a network 460 (which can be similar or identical to the network 132 in FIG. 1). In some implementations, the 3D content generator 416 and/or the components thereof, can instead or in addition be implemented in some or all of the 3D systems 402. For example, the above-described modeling and/or processing can be performed by the system that originates the 3D information before forwarding the 3D information to one or more receiving systems. As another example, an originating system can forward images, modeling data, depth data and/or corresponding information to one or more receiving systems, which can perform the above-described processing. Combinations of these approaches can be used.

As such, the system 400 is an example of a system that includes cameras (e.g., the cameras 404), a depth sensor (e.g., the depth sensor 406), and a 3D content generator (e.g., the 3D content generator 418) having a processor executing instructions stored in a memory. Such instructions can cause the processor to identify, using depth data included in 3D information (e.g., by way of the depth processing component 420), image content in images of a scene included in the 3D information. The image content can be identified as being associated with a depth value that satisfies a criterion. The processor can generate modified 3D information by applying a model generated by 3D content modeler 430 which may be provided to 3D content generator 418 to properly depict the composite image 456, for example.

The composite image 456 represents a 3D stereoscopic image of a particular object 436 with proper parallax and viewing configuration for both eyes associated with the user accessing a display (e.g., display 412) based at least in part on a tracked location of the head of the user. At least a portion of the composite image 456 may be determined based on output from 3D content modeler 430, for example, using system 400 each time the user moves a head position while viewing the display. In some implementations, the composite image 456 represents the object 436 and other objects, users, or image content within a view capturing the object 436.

In some implementations, processors (not shown) of systems 402 and 416 may include (or communicate with) a graphics processing unit (GPU). In operation, the processors may include (or have access to memory, storage, and other processor (e.g., a CPU)). To facilitate graphics and image generation, the processors may communicate with the GPU to display images on a display device (e.g., display device 412). The CPU and the GPU may be connected through a high-speed bus, such as PCI, AGP or PCI-Express. The GPU may be connected to the display through another high-speed interface such as HDMI, DVI, or Display Port. In general, the GPU may render image content in a pixel form. The display device 412 may receive image content from the GPU and may display the image content on a display screen.

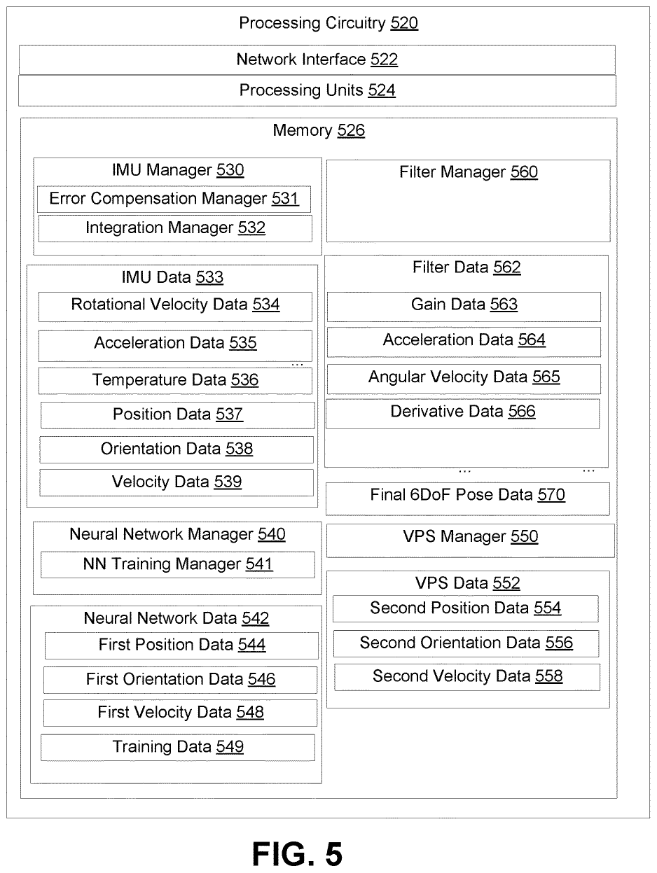

FIG. 5 is a diagram that illustrates an example of processing circuitry 520. In an example implementation, the processing circuitry 520 can include circuitry (e.g., a signal processing pipeline) configured to generate head pose data. The head pose data can be generated based on image data. The head pose data can include errors (e.g., due to rapid head movement like nodding and shaking of the head). The errors can be corrected (e.g., removed or minimized) using a harmonic exponential filter in the processing circuitry used to generate the head pose data. As described below, the processing circuitry 520 can include a filter manager 560 including, for example, the harmonic exponential filter. In other words, the signal processing pipeline configured to generate head pose data can include the filter manager 560.

Further, the processing circuitry 520 can include a network interface 522, one or more processing units 524, and nontransitory memory 526. The network interface 522 includes, for example, Ethernet adaptors, Token Ring adaptors, Bluetooth adaptors, WiFi adaptors, NFC adaptors, and the like, for converting electronic and/or optical signals received from the network to electronic form for use by the processing circuitry 520. The set of processing units 524 include one or more processing chips and/or assemblies. The memory 526 includes both volatile memory (e.g., RAM) and non-volatile memory, such as one or more ROMs, disk drives, solid state drives, and the like. The set of processing units 524 and the memory 526 together form processing circuitry, which is configured and arranged to carry out various methods and functions as described herein. Therefore, the set of processing units 524 and the memory 526 together form processing circuitry the signal processing pipeline configured to generate corrected head pose data using a harmonic exponential filter (e.g., included in the filter manager 560).

In some implementations, one or more of the components of the processing circuitry 520 can be, or can include processors (e.g., processing units 524) configured to process instructions stored in the memory 526. Examples of such instructions as depicted in FIG. 5 include IMU manager 530, neural network manager 540, visual positioning system manager 550, and filter manager 560. Further, as illustrated in FIG. 5, the memory 526 is configured to store various data, which is described with respect to the respective managers that use such data.

The IMU manager 530 is configured to obtain IMU data 533. In some implementations, the IMU manager 530 obtains the IMU data 533 wirelessly. As shown in FIG. 5, the IMU manager 530 includes an error compensation manager 531 and an integration manager 532.

The error compensation manager 531 is configured to receive IMU intrinsic parameter values from the filter manager 560. The error compensation manager 531 is further configured to receive IMU output (IMU data 533) from, e.g., IMU manager 530, and use the IMU intrinsic parameter values to compensate the IMU output for errors. The error compensation manager 531 is then configured to, after performing the error compensation, produce the IMU data 533.

The integration manager 532 is configured to perform integration operations (e.g., summing over time-dependent values) on the IMU data 533. Notably, the rotational velocity data 534 is integrated over time to produce an orientation. Moreover, the acceleration data 535 is integrated over time twice to produce a position. Accordingly, the integration manager 532 produces a 6DoF pose (position and orientation) from the IMU output, i.e., rotational velocity data 534 and acceleration data 535.

The IMU data 533 represents the gyro and accelerometer measurements, rotational velocity data 534 and acceleration data 535 in a world frame (as opposed to a local frame, i.e., frame of the IMU), compensated for an error(s) using the IMU intrinsic parameter values determined by the filter manager 560. Moreover, IMU data 533 includes 6DoF pose and movement data, position data 537, orientation data 538, and velocity data 539, that are derived from the gyro and accelerometer measurements. Finally, in some implementations, the IMU data 533 also includes IMU temperature data 536; this may indicate further error in the rotational velocity data 534 and acceleration data 535.

The neural network manager 540 is configured to take as input the rotational velocity data 534 and acceleration data 535 and produce the neural network data 542 including first position data 544, first orientation data 546, and first velocity data 548. In some implementations, the input rotational velocity data 534 and acceleration data 535 are produced by the error compensation manager 531 acting on raw IMU output values, i.e., with errors compensated by IMU intrinsic parameter values. As shown in FIG. 5, the neural network manager 540 includes a neural network training manager 541.

The neural network training manager 541 is configured to take in training data 549 and produce the neural network data 542, including data concerning layers and cost functions and values. In some implementations, the training data 549 includes movement data taken from measurements of people wearing AR smartglasses and moving their heads and other parts of their bodies, as well as ground truth 6DoF pose data taken from those measurements. In some implementations, the training data 549 includes measured rotational velocities and accelerations from the movement, paired with measured 6DoF poses and velocities.

In addition, in some implementations, the neural network manager 540 uses historical data from the IMU to produce the first position data 544, first orientation data 546, and first velocity data 548. For example, the historical data is used to augment the training data 549 with maps of previous rotational velocities, accelerations, and temperatures to their resulting 6DoF pose and movement results and hence further refine the neural network.

In some implementations, the neural network represented by the neural network manager 540 is a convolutional neural network, with the layers being convolutional layers.

The visual positioning system (VPS) manager 550 is configured to take as input an image and produce VPS data 552, including second position data 554, second orientation data 556; in some implementations, the VPS data also includes second velocity data 558, i.e., 6DoF pose based on an image. In some implementations, the image is obtained with the world-facing camera (e.g., 216) on the frame of the AR smartglasses.

In some implementations, the accuracy level of the VPS manager 550 in producing the VPS data 552 depends on the environment surrounding the location. For example, the accuracy requirements for indoor locations may be on the order of 1-10 cm, while the accuracy requirements for outdoor locations may be on the order of 1-10 m.

The filter manager 560 is configured to produce estimates of the 6DoF pose based on the filter data 562 and return final 6DoF pose data 570 for, e.g., tracking a user head pose or position.

The filter data 562 represents the state and covariances that are updated by the filter manager 560, as well as the residual and error terms that are part of the updating equations. As shown in FIG. 5, the filter data 562 includes gain data 563, acceleration data 564, angular velocity data 565, and derivative data 566.

As mentioned above, human head motion can be harmonic. In other words, natural body motions can be biased towards conserving energy. Therefore, harmonics can be used to in a 6DoF pose correction operation. For example, implementations can generate a head pose predictor that takes advantage of harmonic motions. Therefore, example implementations can use harmonics to (1) extending exponential smoothing to multiple arbitrary features derived from the input sample, (2) estimating a dominant frequency (e.g., based on complex arithmetic) with velocity-accelerator phasor, and (3) improving prediction and extrapolation by assuming harmonic motion.

In the example implementation of FIG. 5, head pose tracking based on cameras can have a signal processing pipeline including filters. Example implementations can be based on (or be an extension of) double exponential filters (DEF) and/or triple exponential filters (TEF). In other words, the filter manager 560 can include a DEF and/or a TEF. The DEF can be configured to filter an input signal (e.g., position). The DEF can be configured to implement linear prediction by simultaneously tracking and filtering velocity. Position and velocity can be expressed as:

$$p = ( 1 - {g}_{p} ) {p}_{0} + {g}_{p} x \qquad ( 1 )$$

$$v = ( 1 - {g}_{v} ) {v}_{0} + {g}_{v} ( v - {v}_{0} ) \qquad ( 2 )$$

where,
p is position,
v is velocity, and
g is gain.

When tracking acceleration, for harmonic motion, linear prediction can overshoot where velocity becomes small, and the acceleration increases. Therefore, an acceleration term can be added to the DEF which can be expressed as:

$$a = ( 1 - {g}_{v} ) {a}_{0} + {g}_{a} ( v - {v}_{0} ) \qquad ( 3 )$$

where a is acceleration.

The term triple exponential smoothing can refer to smoothing using repetition (triple exponential smoothing can be based on the financial background of exponential smoothing algorithms). Example implementations refer to TEF as the algorithm that includes the acceleration term. In other words, TEF can be expressed as shown in eqn. 3.

Example implementations being based on harmonics can allow improving predictions based on TEF by using a phasor. In addition, example implementations can differentiate the phasor and obtain per-sample estimates of the dominant frequency. An observation associated with harmonic motion is that the velocity and acceleration are up to scale phase shifted by . In other words, keeping the amplitude constant, the orbit of the particle can be elliptical and expressed as:

$$x ( t ) = A sin ω t \qquad ( 4 )$$

$$v ( t ) = A ω cos ω t \qquad ( 5 )$$

$$a ( t ) = - A ω 2 sin ω t \qquad ( 6 )$$

where,
ω is angular velocity, and
t is time.

The ellipse can be distorted from a circle by a factor of the angular velocity. Therefore, an example phasor can be expressed as:

$$z ( t ) = A ω {e}^{- i ( ω t + \frac{π}{2} )} = v ( t ) + \frac{i}{ω} a ( t ) \qquad ( 7 )$$

The analogous equation for a sample is:

$$z = v + \frac{i}{ω} a \qquad ( 8 )$$

An assumption could be made that acceleration is constant. However, in an example implementation acceleration can be changing with time. Using the third derivative may not be an option. The harmonic motion that explains that the third derivative is also sinusoidal and not constant. The reason the third derivative cannot be directly estimated is because every derivative of a signal introduces noise and typically the third derivative becomes unusable. Accordingly, the first derivative can be used to approximate the third derivative. For harmonic motions, the third derivative can be estimated using the first derivative, up to a negative scale (see eqn. 9).

Therefore, in an example implementation the derivative can be taken twice to generate a signal that is ω² times smaller than the original signal. Considering an example where the noise standard deviation is 1% of the signal amplitude and the signal is sampled at 60 Hz, we get ω²=(2π/60)²≈0.01, which can be indistinguishable from noise. Direct estimation of the third derivative may be too noisy. Therefore, another way to approximate the third derivative may be necessary. Example implementations can be based on harmonic motion. Therefore, the third derivative may be estimated as:

$$j ( t ) = {a}^{′} ( t ) \approx - {\vert ω \vert}^{2} {ω}^{2} v ( t ) \qquad ( 9 )$$

The third derivative may be evaluated at the time of the acceleration as:

$$j = - {\vert ω \vert}^{2} {ω}^{2} ( \frac{{v}_{0} + {v}_{1}}{2} ) = - {\vert ω \vert}^{2} {ω}^{2} ( {v}_{0} + \frac{{a}_{0}}{2} ) \qquad ( 10 )$$

The analog to the discrete differential in cartesian space can be the division of the phasors (e.g., a derivative in exponential space), which can be expressed as:

$$w = \frac{z}{{z}_{0}} \qquad ( 11 )$$

In order to avoid a potential division by zero, example implementations can expand the complex division and add an ε which can be expressed as:

$$w = \frac{{zz}_{0}^{*} + ϵ}{{z}_{0} {z}_{0}^{*} + ϵ} = {re}^{- i ω} \qquad ( 12 )$$

The log of the phasor can reveal the angular frequency as the imaginary component which can be expressed as:

$$log w = log r - i ω \qquad ( 13 )$$

The estimated angular frequency can be too small or too large. If angular frequency ω is too small, the phasor z can be unusably large. If angular frequency ω is too large, the third derivative can be unusably large. Therefore, example implementations can include limiting the range of valid angular frequencies which can be expressed as:

$$ω = min ( {ω}_{max} , max ( {ω}_{min} , - \text{?} ( log w ) ) ) \qquad ( 14 )$$

In an implementation, the ordinary frequency f can be obtained from the angular frequency ω as:

$$f = ω \frac{τ}{{f}_{s}} \qquad ( 15 )$$

where,
τ=2π, and
fₛ is the sampling frequency (e.g., 60 Hz).

In an example implementation, the harmonic motion representation using phasors can be implemented as follows, including generalization to non-integer steps.

An example implementation can include classic Euler integration. In order to extrapolate using the DEF, the derivatives can be integrated from higher to lower order. A single step extrapolation can be expressed as:

$${v}_{1} = {v}_{0} + {a}_{1} \qquad ( 16 )$$

$${p}_{1} = {p}_{0} + {v}_{1} \qquad ( 17 )$$

An example implementation can include harmonic Euler integration. In this example, the harmonic assumption can be used for a single step extrapolation which can be expressed as:

$${z}_{1} = {z}_{0} {w}_{1} \qquad ( 18 )$$

$${p}_{1} = {p}_{0} + \text{?} ( {z}_{1} ) \qquad ( 19 )$$

An example implementation can include a geometric series. In this example, when extrapolating multiple steps n, a geometric series can be expressed as:

$${v}_{tot} = \text{?} ( {z}_{0} ( w + {w}^{2} + {w}^{3} + … ) ) \qquad ( 20 )$$

$${p}_{n} = {p}_{0} + {v}_{tot} \qquad ( 21 )$$

A simplified geometric series can be expressed as:

$${v}_{tot} = \text{?} [ {z}_{0} ( \frac{1 - {w}^{n + 1}}{1 - w} - 1 ) ] , w \neq 1 \qquad ( 22 )$$

$${v}_{tot} = \text{?} [ {z}_{0} n ] , w = 1 \qquad ( 23 )$$

There can be two benefits from this simplification (1) an ability to extrapolate with a latency value that is a non-integer number of samples, and (2) a constant time complexity instead of linear complexity in latency. In order to improve numerical stability, the two equations (eqn. 23 and eqn. 23) can be unified which can be expressed as:

$${v}_{tot} = \text{?} [ {z}_{0} ( \frac{w - {w}^{n + 1} + ϵ}{1 - w + ϵ} ) ] \qquad ( 24 )$$

An example implementation can include fractional steps. For example, given a latency t_{d}, the time n in units of samples to predict n, which can be expressed as:

$$n = \frac{{t}_{d}}{{T}_{s}} = {t}_{d} {f}_{s} \qquad ( 25 )$$

where Tₛ and fₛ are the sampling period and sampling frequency respectively.
   There may be no particular reason for the number of samples to be exact multiples of the sampling period. Therefore, example implementations may include non-integer samples for prediction. The number of samples can appear as an exponent. Therefore, example implementations can generalize from integer to fractional samples. In the complex domain examples can take powers using non-integer exponents which can be expressed as:

$${w}^{n} = {e}^{n log w} \qquad ( 26 )$$

Accordingly, the power can be calculated in constant time.

In order to avoid the singularity around 0, an example implementation can include adding, for example a small, epsilon when performing complex division in order to obtain the change of phasor @ and the accumulated extrapolation step vₜₒₜ which can be expressed as:

$$\frac{a}{b} \to \frac{{ab}^{*} + ϵ}{{bb}^{*} + ϵ} \qquad ( 27 )$$

In an example implementation, there can be many variables that may need to be consistent at the beginning of a process. Therefore, getting the initial condition correct using the first (e.g., 3, 4, 5, and the like) samples may be relatively challenging. Therefore, instead of assuming simple initial conditions, example implementations can start sampling at rest (e.g., v=0 and a=0). This can be achieved by blending with a smooth ease-in function on the first (e.g., approximately 30) samples.

Picking good parameters can be important to achieve a good performance of the predictor. Therefore, good gain values can be empirically obtained by running a simulation in real time using a Gaussian-windowed sine wave at, for example, frequencies 1, 2, and 4 Hz. As an example, the values can be as follows:

$$\begin{matrix}{g}_{p} = 0.66 \\ {g}_{v} = 0.66 \\ {g}_{a} = 0.10 \\ {g}_{z} = 0.35 \\ {g}_{ω} = 0.13 \\ {g}_{l} = 0.25\end{matrix}$$

The two gain values g_{P} and gᵥ can be increased up to, for example, one (1) with, for example, a moderate increase of noise and a reduction of bias without, for example, impacting total mean squared error (MSE) or peak signal-to-noise ratio (PSNR). The gain values may be tuned for low frequencies (e.g., up to 5 Hz) and a low number of latency samples (e.g., up to 5 steps).

The components (e.g., modules, processing units 524) of processing circuitry 520 can be configured to operate based on one or more platforms (e.g., one or more similar or different platforms) that can include one or more types of hardware, software, firmware, operating systems, runtime libraries, and/or so forth. In some implementations, the components of the processing circuitry 520 can be configured to operate within a cluster of devices (e.g., a server farm). In such an implementation, the functionality and processing of the components of the processing circuitry 520 can be distributed to several devices of the cluster of devices.

The components of the processing circuitry 520 can be, or can include, any type of hardware and/or software configured to process attributes. In some implementations, one or more portions of the components shown in the components of the processing circuitry 520 in FIG. 5 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 520 can be, or can include, a software module configured for execution by at least one processor (not shown). In some implementations, the functionality of the components can be included in different modules and/or different components than those shown in FIG. 5, including combining functionality illustrated as two components into a single component.

Although not shown, in some implementations, the components of the processing circuitry 520 (or portions thereof) can be configured to operate within, for example, a data center (e.g., a cloud computing environment), a computer system, one or more server/host devices, and/or so forth. In some implementations, the components of the processing circuitry 520 (or portions thereof) can be configured to operate within a network. Thus, the components of the processing circuitry 520 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, IMU manager 530 (and/or a portion thereof), neural network manager 540 (and/or a portion thereof), VPS manager 550, and filter manager 560 (and/or a portion thereof are examples of such instructions.

In some implementations, the memory 526 can be any type of memory such as a random-access memory, a disk drive memory, flash memory, and/or so forth. In some implementations, the memory 526 can be implemented as more than one memory component (e.g., more than one RAM component or disk drive memory) associated with the components of the processing circuitry 520. In some implementations, the memory 526 can be a database memory. In some implementations, the memory 526 can be, or can include, a non-local memory. For example, the memory 526 can be, or can include, a memory shared by multiple devices (not shown). In some implementations, the memory 526 can be associated with a server device (not shown) within a network and configured to serve the components of the processing circuitry 520.

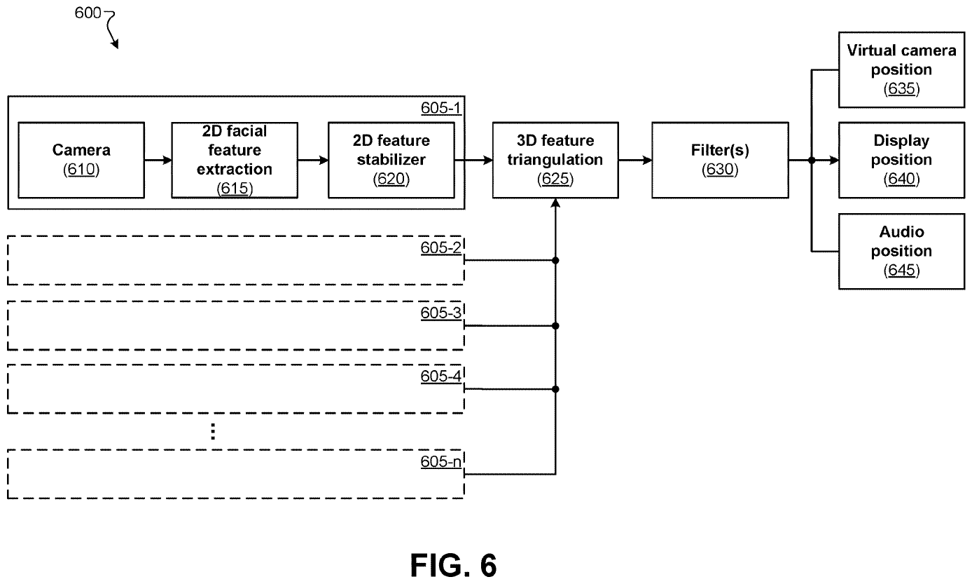

FIG. 6 is a block diagram of a system for tracking and correcting head pose data according to at least one example embodiment implementation. The example system 600 can be configured to use a harmonic exponential filter to generate corrected head pose data. For example, the system 600 can include a signal processing pipeline including the harmonic exponential filter. The signal processing pipeline can receive an image(s) and generate head pose data based on the images. The head pose data can include errors (e.g., due to rapid head movement like nodding and shaking of the head). Therefore, the signal processing pipeline can include the harmonic exponential filter to correct for (e.g., reduce, minimize, and/or the like) the errors. Accordingly, the system 600 can be configured to at least address some of the technical problems described above.

As shown in FIG. 6 a system 600 includes a feature tracker 605 block, a 3D feature triangulation 625 block, a filter(s) 630 block, a virtual camera position 635 block, a display position 640 block, and an audio position 645 block. The feature tracker 605 block includes a camera 610 block, a 2D facial feature extraction 615 block, and a 2D feature stabilizer 620 block. Example implementations can include a plurality of feature trackers (shown as feature tracker 605-1 block, feature tracker 605-2 block, feature tracker 605-3 block, feature tracker 605-4 block, . . . , and feature tracker 605-n block). Example implementations can include using at least two (2) feature trackers 605. For example, implementations can use four (4) feature trackers 605 in order to optimize (e.g., increase) accuracy, optimize (e.g., decrease) noise and optimize (e.g., expand) the capture volume as compared to systems using less than four (4) feature trackers 605.

The camera 610 can be a monochrome camera operating at, for example, 120 frames per second. When using two or more cameras, the cameras 610 can be connected to a hardware trigger to ensure the cameras 610 fire at the same time. The resulting image frames can be called a frame set, where each frame in the frame set is taken at the same moment in time. The camera 610 can also be an infrared camera having similar operating characteristics as the monochrome camera. The camera 610 can be a combination of monochrome and infrared cameras. The camera 610 can be a fixed camera in a 3D content system (e.g., camera 116, 118, 120, 122). The camera 610 can be a free-standing camera coupled to a 3D content system (e.g., camera 114, 114′, 114″, 134, 134′, 134″). The camera 610 can be a combination of fixed and free-standing cameras. The plurality of cameras can be implemented in a plurality of feature trackers 605.

The 2D facial feature extraction 615 can be configured to extract facial features from an image captured using camera 610. Therefore, the 2D facial feature extraction 615 can be configured to identify a face of a user (e.g., a participant in a 3D telepresence communication) and extract the facial features of the identified face. A face detector (face finder, face locator, and/or the like) can be configured to identify faces in an image. The face detector can be implemented as a function call in a software application. The function call can return the rectangular coordinates of the location of a face. The face detector can be configured to isolate on a single face should there be more than one user in the image.

Facial features can be extracted from the identified face. The facial features can be extracted using a 2D ML algorithm or model. The facial features extractor can be implemented as a function call in a software application. The function call can return the location of facial features (or key points) of a face. The facial features can include, for example, eyes, mouth, ears, and/or the like. Face recognition and facial feature extraction can be implemented as a single function call that returns the facial features and/or a position or location of the facial features.

The 2D feature stabilizer 620 can be configured to reduce noise associated with a facial feature(s). For example, a filter can be applied to the 2D feature locations (e.g., facial feature(s) locations) in order to stabilize the 2D feature. In an example implementation, the filter can be applied to reduce the noise associated with the location of the eyes. In at least one example implementation, at least two images can be used for feature stabilization.

In an example implementation, stabilizing the eyes (e.g., as a location of a 2D feature) can include determining the center of each eye by averaging location of the facial feature(s) around each eye. Averaging the location of the facial feature(s) around the eyes can reduce noise associated with these facial feature(s) because the noise associated with two or more facial feature(s) may not be correlated.

The stabilizing of the location of the facial feature (e.g., eyes) can be based on the motion of the head or face. The motion (e.g., velocity) of the head or face can be used to further reduce the noise. A set of all the facial feature(s) can be generated and a subset of facial feature(s) that that are substantially stable is determined. For example, particularly noisy facial feature(s) can be excluded. For example, the ears and cheeks can present a high level of noise and inaccuracy. Therefore, the facial feature(s) associated with the ears and cheeks can be excluded in order to generate a substantially stable subset of facial feature(s). Determining the average motion of the head or face can include calculating the average 2D velocity of the subset of facial feature(s). Considering that the eye sockets are fixed with relation to the rest of the face, the average velocity of the face should be close to that of the eye sockets. Therefore, the velocity of the averaged eye centers and the average velocity of the subset of facial feature(s) can be added. The averaged eye centers and the average velocity of the subset of facial feature(s) can be added with a preselected set of weights. For example, the facial velocity can be weighted at 90% and the eye center velocity can be weighted at 10%. Stabilized eye features can be based on the original location of the eyes and the calculated average velocity.

The 3D feature triangulation 625 can be configured to obtain a 3D position of a facial feature(s). In other words, the 2D location (or position) of the facial feature can be converted to a three-dimensional (3D) location (or position). In an example implementation, the location and orientation (with respect to another camera and/or a display) of the cameras (e.g., cameras 114, 114′, 114″, 116, 118) and the 3D display (e.g., display 110, 112) is known (e.g., through use of a calibration when setting up the 3D telepresence system). An X and Y coordinate in 2D image space for each camera used to capture an image including a facial feature(s) can be determined. A ray can be generated for each camera feature pair. For example, a ray that originates at the pixel location of the facial feature(s) (e.g., an eye) to each camera can be drawn (e.g., using a function call in software). For four cameras, four rays can be generated. A 3D location of a facial feature(s) can be determined based on the rays (e.g., four rays). For example, a location where the rays intersect (or where they approach intersection) can indicate the 3D location of the facial feature(s) (e.g., the left eye).

The filter(s) 630 can be configured to reduce noise associated with a 3D facial feature(s). Although facial feature(s) noise was reduced using the 2D feature stabilizer 620, there can be some residual noise associated with a 3D facial feature(s) location (or position). The residual noise can be amplified by, for example, environmental conditions or aspects of the user (e.g., glasses, facial hair, and/or the like). The filter(s) 630 can be configured to reduce this residual noise.

In a 3D telepresence system, the tracking-display system can have an inherent latency. The latency can be from the time the photons capturing the user's new position get received by the head tracking cameras to the time the newly calculated position is sent to the renderer and ultimately sent to the display where the pixels of the display change row by row. In some cases, the delay can be approximately 60 milliseconds. The latency can cause errors or noise (in addition to the residual noise) in head pose data (e.g., due to rapid head movement like nodding and shaking of the head). Therefore, the filter(s) 630 can be configured to reduce this noise as well.

As mentioned above, human head motion can be harmonic. In other words, natural body motions can be biased towards conserving energy. Therefore, harmonics can be used to in a head pose correction operation. For example, implementations can generate a head pose predictor that takes advantage of harmonic motions. Therefore, example implementations can use harmonics to (1) extending exponential smoothing to multiple arbitrary features derived from the input sample, (2) estimating a dominant frequency (e.g., based on complex arithmetic) with velocity-accelerator phasor, and (3) improving prediction and extrapolation by assuming harmonic motion. Accordingly, the filter(s) 630 can be or include a harmonic exponential filter. Details associated with the harmonic exponential filter are provided below.

The virtual camera position 635, the display position 640, and the audio position 645 can use the current value for the location of the facial feature(s) as data for the tracking process as a binary that can be used for driving the display, as input to a renderer for presenting the virtual scene (e.g., for determining a position for left eye scene and right eye scene), and as a binary that can be used for projecting audio (e.g., for determining stereo balance between the left ear and the right ear).

The above description of FIG. 6 is for identifying and determining the position of a single face. However, example implementations are not limited to identifying and determining the position of a single participant in the communication. In other words, two or more participants can be identified and located. Therefore, example implementations can include identifying and determining the position of two or more faces along with the eyes, ears, and/or mouth of each face for the purpose of driving a 3D display and 3D rendering system and/or driving an audio system.

3D rendering can include rendering a 3D scene from a desired point of view (POV) (e.g., determined as the location of a face) using a 3D image rendering system. For example, the head tracking techniques described herein can be used to determine two POVs (one for the left and right eye) of each user viewing the display. These viewpoints can then become inputs to the 3D rendering system for rendering the scene. In addition, auto-stereo displays may require taking the images meant for the left and right eyes of each user and mapping those to individual screen pixels. The resulting image that is rendered on the LCD panel (e.g., below the lenticular panel) can appear as though many images are interleaved together. The mapping can be determined by the optical properties of the lens (e.g., how pixels map to rays in space along which they are visible). The auto-stereo display can include any auto-stereo display capable of presenting a separate image to a viewer's left and right eye. One such type of display can be achieved by locating a lenticular lens array in front of an LCD panel, offset by a small distance.

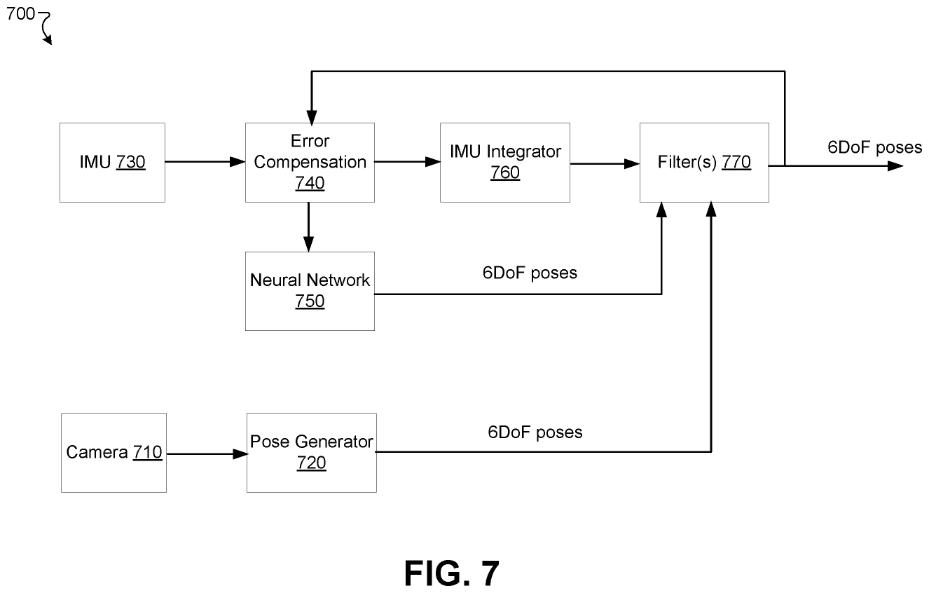

FIG. 7 is a flow chart illustrating an example flow 700 for generating corrected head pose data. The flow 700 may be performed by software constructs described in connection with FIG. 5, which reside in memory 526 of the processing circuitry 520 and are run by the set of processing units 524.

At 710, a world-facing camera obtains images of a scene at discrete instants of time.

At 720, a pose generator module generates 6DOF head pose data based on the images.

At 730, the IMU measures a rotational velocity and acceleration at discrete instants of time. The IMU may also produce a temperature at the instant.

At 740, an error compensation manager (e.g., error compensation manager 531) compensates the rotational velocity and acceleration values at the instants of time with error compensation values based on feedback parameter values to produce error-compensated rotational velocity and acceleration values.

At 760, an IMU integrator integrates the error-compensated rotational velocity and acceleration values to produce an integrated 6DoF pose and velocity. Specifically, the rotational velocity is accelerated once to produce an orientation, while the acceleration is integrated once to produce a velocity and once more to produce a position.

At 750, a neural network module obtains the error-compensated rotational velocity and acceleration values as input into a convolutional neural network model to produce a second 6DoF pose and a second velocity. The neural network module may perform the neural network modeling and produce the first 6DoF pose and first velocity at a rate of 10-200 Hz. The first 6DoF pose provides constraints on human motion, as that constraint is reflected in the training data.

At 770, the filter takes in—at their respective frequencies—image based 6DOF pose(s) and/or IMU. This implies at most, every second epoch has a VPS measurement—in most cases, every tenth epoch has a VPS measurement—while every epoch has a neural network measurement. The filter then provides accurate estimates of the 6DoF pose.

An example code (e.g., C++) segment can be as follows:

#include <algorithm>
#include <cmath>
#include <complex>
struct HarmonicExponentialFilter {
using Complex = std::complex<float>;
// Constants
float epsilon = 1E−5; // Small offset to avoid division by
zero
float sampling_freq = 60; // Sampling frequency
float ratio = 2.0f * M_PI / sampling_freq; // Ratio of angular frequency
to frequency
float min_omega = 0.5f * ratio; // Minimum angular frequency
float max_omega = 10.0f * ratio; // Maximum angular frequency
// Golden gains
float gain_p = 0.66f;
float gain_v = 0.66f;
float gain_a = 0.10f;
float gain_z = 0.35f;
float gain_w = 0.13f;
float gain_l = 0.25f;
// State
bool init = false; // Initialized state
float p = 0; // Position
float v = 0; // Velocity
float a = 0; // Acceleration
Complex z = 0.0f; // Velocity-acceleration phasor
Complex w = 1.0f; // Change of phasor
Complex l = 0.0f; // Log of change of phasor
float omega = min_omega; // Discrete angular frequency
template <typename T>
T Lerp(float gain, Tx0, Tx1) {
return (1.0f − gain) * x0 + gain * x1;
}
Complex Div(Complex a, Complex b) {
return (a * std::conj(b) + epsilon) / (b * std::conj(b) + epsilon);
}
void Add(float x) {
if (!init) {
p = x;
init = true;
return;
}
// Store old values.
float p0 = p;
float v0 = v;
float a0 = a;
Complex z0 = z;
Complex w0 = w;
Complex l0 = 1;
// Predict values.
Complex l1 = l0;
Complex w1 = w0;
Complex z1 = z0 * w1;
float j1 = −(v0 + a0 / 2.0f) * std::norm(omega * w);
float a1 = a0 + j1;
float v1 = v0 + a1;
float p1 = p0 + v1;
// Blend predicted values with new values.
p = Lerp(gain_p, p1, x);
v = Lerp(gain_v, v1, p − p0);
a = Lerp(gain_a, a1, v − v0);
z = Lerp(gain_z, z1, Complex(v, a / omega));
w = Lerp(gain_w, w1, Div(z, z0));
l = Lerp(gain_l, l1, std::log(w));
// Enforce angular frequency bounds.
omega = std::clamp(−1.imag( ), min_omega, max_omega);
}
float Extrapolate(float steps) {
Complex w_steps = Div(w − w * std::exp(1 * steps), 1.0f − w);
return p + std::real(z * w_steps);
}
};

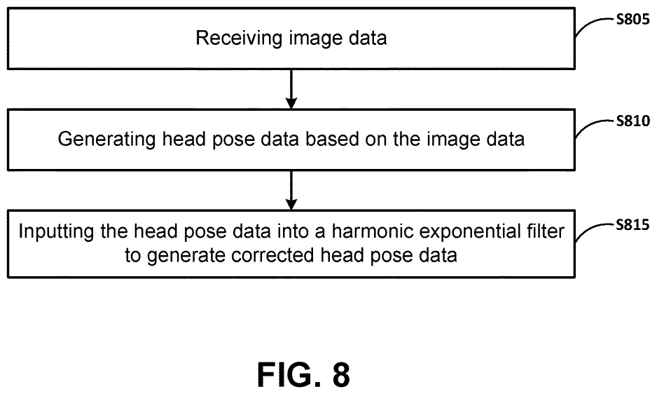

Example 1. FIG. 8 is a block diagram of a method of generating corrected head pose data according to an example implementation. As shown in FIG. 8, in step S805 receiving image data. In step S810 generating head pose data based on the image data. In step S815 inputting the head pose data into a harmonic exponential filter to generate corrected head pose data. The image data can represent an image of a scene from a world-facing camera on a frame of a smartglasses device. The image data can represent image data captured by two or more images captured by cameras of a videoconference and/or telepresence system.

Example 2. The method of Example 1, wherein the image data can include two or more images, and the two or more images can be captured at least one of sequentially by the same camera and at the same time by two or more cameras.

Example 3. The method of Example 1 or Example 2 can further include triangulating a location of at least one facial feature based on location data generated using the image data, wherein the image data can be based on images captured by three or more cameras, the head pose data can be generated using the triangulated location of the at least one facial feature.

Example 4. The method of Example 4, wherein the head pose data can be generated based on a velocity associated with the triangulated location of the at least one facial feature.

Example 5. The method of Example 1, wherein the head pose data can be first head pose data and the corrected head pose data can be first corrected head pose data, the method can further include receiving inertial measurement unit (IMU) data from an IMU, the IMU data including values of a rotational velocity and an acceleration, the IMU being connected to the world-facing camera, generating second head pose data based on the values of the rotational velocity and the acceleration, the second head pose data representing a position and orientation of the IMU, inputting the second head pose data into the harmonic exponential filter to generate corrected second head pose data, and generating third head pose data based on the first corrected head pose data and the second corrected head pose data.

Example 6. The method of Example 1, wherein the head pose data can be first head pose data and the corrected head pose data can be first corrected head pose data, the method can further include receiving inertial measurement unit (IMU) data from an IMU, the IMU data including values of a rotational velocity and an acceleration, the IMU being connected to the world-facing camera, generating second head pose data based on the values of the rotational velocity and the acceleration, the second head pose data representing a position and orientation of the IMU, inputting the second head pose data into a Kalman filter to generate corrected second six-degree-of-freedom head pose data, and generating third head pose data based on the first corrected head pose data and the second corrected head pose data.

Example 7. The method of any of Example 1 to Example 6, wherein the harmonic exponential filter can combine six (6) exponential filters.

Example 8. The method of any of Example 1 to Example 6, wherein the harmonic exponential filter can be a double exponential filter including an acceleration variable.

Example 9. The method of any of Example 1 to Example 6, wherein the harmonic exponential filter can be one of a double exponential filter including a velocity and acceleration phasor variable.

Example 10. The method of any of Example 1 to Example 9, wherein the harmonic exponential filter can include a compensation variable associated with an acceleration that changes with time.

Example 11. The method of any of Example 1 to Example 10, wherein the harmonic exponential filter can use complex phasors to perform filtering and prediction of harmonic motion.

Example 12. A method can include any combination of one or more of Example 1 to Example 11.

Example 13. A non-transitory computer-readable storage medium comprising instructions stored thereon that, when executed by at least one processor, are configured to cause a computing system to perform the method of any of Examples 1-12.

Example 14. An apparatus comprising means for performing the method of any of Examples 1-12.

Example 15. An apparatus comprising at least one processor and at least one memory including computer program code, the at least one memory and the computer program code configured to, with the at least one processor, cause the apparatus at least to perform the method of any of Examples 1-12.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method, comprising:
receiving image data;
generating head pose data based on the image data; and
inputting the head pose data into a harmonic exponential filter to generate corrected head pose data.

2. The method of claim 1, wherein
the image data includes two or more images, and
the two or more images are captured at least one of sequentially by a same camera and at a same time by two or more cameras.

3. The method of claim 1, further comprising:
triangulating a location of at least one facial feature based on location data generated using the image data, wherein
the image data is based on images captured by three or more cameras, and
the head pose data is generated using the triangulated location of the at least one facial feature.

4. The method of claim 3, wherein the head pose data is generated based on a velocity associated with the triangulated location of the at least one facial feature.

5. The method of claim 1, wherein the image data represents an image of a scene from a world-facing camera on a frame of a smartglasses device.

6. The method of claim 5, wherein the head pose data is first head pose data and the corrected head pose data is first corrected head pose data, the method further comprising:
receiving inertial measurement unit (IMU) data from an IMU, the IMU data including values of a rotational velocity and an acceleration, the IMU being connected to the world-facing camera;
generating second head pose data based on the values of the rotational velocity and the acceleration, the second head pose data representing a position and orientation of the IMU;
inputting the second head pose data into the harmonic exponential filter to generate second corrected head pose data; and
generating third head pose data based on the first corrected head pose data and the second corrected head pose data.

7. The method of claim 5, wherein the head pose data is first head pose data and the corrected head pose data is first corrected head pose data, the method further comprising:
receiving inertial measurement unit (IMU) data from an IMU, the IMU data including values of a rotational velocity and an acceleration, the IMU being connected to the world-facing camera;
generating second head pose data based on the values of the rotational velocity and the acceleration, the second head pose data representing a position and orientation of the IMU;
inputting the second head pose data into a Kalman filter to generate second corrected head pose data; and
generating third head pose data based on the first corrected head pose data and the second corrected head pose data.

8. The method of claim 1, wherein the harmonic exponential filter combines six (6) exponential filters.

9. The method of claim 1, wherein the harmonic exponential filter is a double exponential filter including an acceleration variable.

10. The method of claim 1, wherein the harmonic exponential filter is a double exponential filter including a velocity and acceleration phasor variable.

11. The method of claim 1, wherein the harmonic exponential filter includes a compensation variable associated with an acceleration that changes with time.

12. The method of claim 1, wherein the harmonic exponential filter uses complex phasors to perform filtering and prediction of harmonic motion.

13. A non-transitory storage medium including code that, when executed by processing circuitry, causes the processing circuitry to:
receive image data;
generate head pose data based on the image data; and
input the head pose data into a harmonic exponential filter to generate corrected head pose data.

14. (canceled)

15. The non-transitory storage medium of claim 13, wherein the code that, when executed by processing circuitry, further causes the processing circuitry to:
triangulate a location of at least one facial feature based on location data generated using the image data, wherein
the image data is based on images captured by three or more cameras, and
the head pose data is generated using the triangulated location of the at least one facial feature.

16. The non-transitory storage medium of claim 15, wherein the head pose data is generated based on a velocity associated with the triangulated location of the at least one facial feature.

17. The non-transitory storage medium of claim 13, wherein the head pose data is first head pose data and the corrected head pose data is first corrected head pose data, the code that, when executed by processing circuitry, further causes the processing circuitry to:
receive inertial measurement unit (IMU) data from an IMU, the IMU data including values of a rotational velocity and an acceleration, the IMU being connected to a world-facing camera;
generate second head pose data based on the values of the rotational velocity and the acceleration, the second head pose data representing a position and orientation of the IMU;
input the second head pose data into the harmonic exponential filter to generate second corrected head pose data; and
generate third head pose data based on the first corrected head pose data and the second corrected head pose data.

18. The non-transitory storage medium of claim 13, wherein the head pose data is first head pose data and the corrected head pose data is first corrected head pose data, the code that, when executed by processing circuitry, further causes the processing circuitry to:
receive inertial measurement unit (IMU) data from an IMU, the IMU data including values of a rotational velocity and an acceleration, the IMU being connected to a world-facing camera;
generate second head pose data based on the values of the rotational velocity and the acceleration, the second head pose data representing a position and orientation of the IMU;
input the second head pose data into a Kalman filter to generate second corrected head pose data; and
generate third head pose data based on the first corrected head pose data and the second corrected head pose data.

19. The non-transitory storage medium of claim 13, wherein the harmonic exponential filter combines six (6) exponential filters.

20. The non-transitory storage medium of claim 13, wherein the harmonic exponential filter is a double exponential filter including at least one of a velocity variable and an acceleration variable.

21-23. (canceled)

24. An apparatus, comprising:
memory; and
processing circuitry coupled to the memory, the processing circuitry being configured to:
receive image data;
generate head pose data based on the image data; and
input the head pose data into a harmonic exponential filter to generate corrected head pose data.

25-34. (canceled)
